(19) United States
(12) Patent Application Publication
(10) Pub. No.: US 2022/0329577 A1
(43) Pub. Date: Oct. 13, 2022

(54) Two-Factor Authentication to Authenticate Users in Unconnected Devices

(71) Applicant: Biosense Webster (Israel) Ltd., Yokneam (IL)

(72) Inventors: Eliyahu Ravuna, Kiryat Ata (IL); Shlomo Am-shalem, Haifa (IL); Schmuel Cohen, Yokneam Illit (IL); Hue Nguyen, Fountain Valley, CA (US); Or Yaacobovich, Metula (IL)

(21) Appl. No.: 17/665,384

(22) Filed: Feb. 4, 2022

Related U.S. Application Data
(60) Provisional application No. 63/174,269, filed on Apr. 13, 2021.

(51) Int. Cl. H04L 9/40; H04L 9/32

(52) U.S. Cl. CPC H04L 63/0442; H04L 63/083; H04L 9/3247; H04L 2463/082

(57) ABSTRACT

In one exemplary mode, a method to authenticate a user includes connecting to a mobile storage device, which stores an expiration value and a digital signature of login details, the login details comprising at least a username and the expiration value, receiving the digital signature and the expiration value from the mobile storage device, receiving a user input of a personal identification code, verifying the digital signature responsively to the expiration value and the username to authenticate the expiration value and the username, checking that the expiration value has not expired, and providing access to a computing resource logged in under the username responsively to the expiration value and the username being authenticated, the expiration value having not expired, and the personal identification code.

### RELATED APPLICATION INFORMATION

The present application claims benefit of U.S. Provisional Patent Application Ser. 63/174,269 filed 13 Apr. 2021, the disclosure of which is hereby incorporated herein by reference.

### FIELD OF THE DISCLOSURE

The present disclosure relates to computing devices, and in particular, but not exclusively to, user authentication.

### BACKGROUND

Technicians may visit different sites, such as medical centers, to perform maintenance tasks on local devices, e.g., medical systems such as CARTO® 3 System of Biosense Webster Inc., Irvine, Calif. The local devices may not be connected to the Internet, and this poses a challenge to give technicians access to the local devices and keep track of which technicians have logged into which local devices.

U.S. Pat. No. 8,046,587 to Gantman, et al., describes a method for granting authenticated access to off-line, limited-resource mobile devices. A public-private key pair is generated by a service provider and the public key is used to digitally sign a username and (possibly) access privileges to obtain a password for technician. The public key is securely distributed to mobile devices. When off-line, a mobile device may authenticate access to restricted functions of the mobile device by a technician. The technician provides its username, access privileges and password to the mobile device. The mobile device then uses the public key, username and access privileges to verify the password. To invalidate an old username and password, the service provider replaces the public-private key pair with a new public-private key pair.

PCT Publication WO2013123453 of Bartucci, et al., describes a portable electronic memory device (e.g., USB flash drive). Exemplary modes include portable electronic memory devices having a keypad, encryption hardware, and the ability to encrypt, decrypt, or serve as an authentication tool for a remote computing system without requiring special drivers to be installed on the receiving system.

U.S. Pat. No. 9,118,662 to Corrion describes a method and a system for extending distributed logon services to an off-line computing device includes encrypting, on the off-line computing device, a one-time password (OTP), a nonce, and a unique identifier to generate an authorization request message. Using a mobile device as a proxy to forward the authorization request message to an access control server for authorization. Decrypting the authorization response message to obtain the nonce. Re-encrypting the nonce to generate an authorization response message. Using the mobile device as a proxy to forward the authorization response message to the off-line computing device. Decrypting the authorization response message to obtain the nonce. Comparing the nonce obtained from the authorization response message with the original nonce. The computing device to permit or deny access as result of comparing the nonce obtained from the authorization response message with the original nonce.

U.S. Pat. No. 10,326,733 to Bokare, et al., describes a computer-implemented method for facilitating single sign-on for multiple devices may include (1) establishing a login session for a user account, (2) in response to establishing the login session, providing, to a device associated with the user account, a session token for the user account, (3) receiving, from at least one client, a request to access resources associated with the user account, (4) determining that the associated device possesses the session token for the user account, and (5) in response to determining that the associated device possesses the session token, providing, to the client, access to the resources associated with the user account.

US Patent Publication 2015/0220917 of Aabve, et al., describes methods, devices, and systems for verifying tokens using limited-use certificates. For example, a user device can send a token request to a token provider computer, and receive in response a token and a token certificate associated with the token. The token certificate may include, for example, a hash of the token and a digital signature by the token provider computer or another trusted entity. The user device can provide the token and the token certificate to an access device. The access device can verify the token using the token certificate, and verify the token certificate using a digital signature. In some cases, the token and token certificate may be verified offline. The access device can then conduct a transaction using the token.

U.S. Pat. No. 8,321,953 to Jevans describes a system to authorize access to secured data storage comprising a user interface configured to receive a user code offline from a user to allow access to stored data, circuitry configured to authorize access to the stored data based, at least in part, on the user code and provide access to the stored data, and a storage system configured to store the stored data.

Security Assertion Markup Language (SAML) is an open standard for exchanging authentication and authorization data between parties, in particular, between an identity provider and a service provider. SAML is described in more detail at en.wikipedia.org/wiki/Security_Assertion_Markup_Language.

### BRIEF DESCRIPTION OF THE DRAWINGS

The present disclosure will be understood from the following detailed description, taken in conjunction with the drawings in which:

FIG. 1 is a partly pictorial, partly block diagram view of a two-factor authorization system constructed and operative in accordance with an exemplary mode of the present disclosure;

FIG. 2 is a flowchart including steps in a method of generating an authentication file for use in the system of FIG. 1;

FIG. 3 is a schematic view of a user interface screen used by a user to generate the authentication file in the system of FIG. 1;

FIG. 4 is a schematic view of a mobile storage device with the authentication file stored therein for use with the system of FIG. 1;

FIG. 5 is a flowchart including steps in a method of verifying the authentication file to provide access to a computing resource in the system of FIG. 1;

FIG. 6 is a schematic view of a user interface screen used by a user to login to a computing resource in the system of FIG. 1;

FIG. 7 is a flowchart including steps in an alternative method of generating an authentication file for use in the system of FIG. 1;

FIG. 8 is a flowchart including steps in an alternative method of verifying the authentication file to provide access to a computing resource in the system of FIG. 1;

FIG. 9 is a schematic view of the mobile storage device of FIG. 4 with the authentication file with more data stored therein for use with the system of FIG. 1; and

FIG. 10 is a flowchart including steps in an alternative method of verifying the authentication file to provide access to a computing resource and replace a user revocation list and/or public key list in the system of FIG. 1.

### DESCRIPTION OF EXEMPLARY MODES

### Overview

As previously mentioned, technicians may visit different sites, such as medical centers, to perform maintenance tasks on local devices, e.g., medical systems such as CARTO® 3 System of Biosense Webster Inc., Irvine, Calif.

The local devices may not be connected to the Internet or via any suitable network and this poses a challenge to give technicians access to the local devices and keep track of which technicians have logged into which local devices.

One solution is to use the same hardcoded password for all technicians on all local devices. This however provides low level security and does not uniquely identify the individual technicians. Also, when a technician is no longer employed to maintain the local devices, the technician we still be able to access the local devices.

Exemplary modes of the present disclosure solve the above problems by using two-factor authentication and a mobile (e.g., portable) storage device to store an authentication file to authenticate individual users (e.g., technicians) for use of computing resources at different unconnected processing devices.

A technician receives an authentication file from an online authorization application (e.g., a web application). The authentication file is then stored in a mobile storage device such as a flash disk, CD, DVD or SD card. The authentication file allows the technician to access computing resources of the different unconnected processing devices. The technician then takes the mobile storage device to one of the unconnected processing devices and is provided access to that processing device responsively to verifying the authentication file stored in the mobile storage device. The process of providing the authentication file and using the authentication file is now described in more detail.

A technician logs in to an online authorization application running on a server (e.g., a web application hosted by a web server) or any suitable application which may be accessed from multiple locations within a network (e.g., the Internet or an intranet). The login to the online application may include the technician supplying a username and password which are authenticated by the application. After the username and password are authenticated, the authorization application prompts the technician to enter a personal identification code (PIC), which may include numbers and/or letters and/or symbols. The PIC is typically chosen by the technician. Alternatively, the PIC could be provided by the authorization application. The authorization application generates an expiration value (e.g., an expiration date) which may be any suitable value. For example, the expiration value may be for a given number of hours, days, weeks or months after a current time/date. The authorization application generates a digital signature of login details including the expiration value and the username. The login details may also include one or more access rights that determine the functionality that the technician is allowed to access, for example permissions, access level or type of user. The digital signature is typically generated using asymmetric encryption using a private key (e.g., based on a certificate including the private key) of an authorization body such as the technician's employer. The authorization application then encrypts the digital signature, expiration value and the username (e.g., using symmetric encryption using a key based on the PIC). The digital signature, expiration value and the username may be encrypted as a single encrypted item or as separate encrypted items. The authorization application then stores the encrypted digital signature, expiration value and username (e.g., the encrypted authentication file) in an authentication file in the mobile storage device of the technician. In some exemplary modes, the expiration value may be left in the clear (i.e., not encrypted) and stored in the clear in the mobile storage device.

Once the authentication file or relevant values are stored in the mobile storage device, the technician may take the mobile storage device to any of the unconnected processing devices. At one of the selected unconnected processing devices the technician enters the PIC in a user interface screen rendered by an authentication application running on that processing device and the technician requests opening of the authentication file stored in the mobile storage device. The authentication application receives the authentication file, and decrypts the authentication file (e.g., using symmetric decryption responsively to a key based on the PIC). The authentication application then verifies the digital signature responsively to the username and expiration value stored in the authentication file. The digital signature is typically verified using asymmetric encryption using a public key (e.g., based on a certificate including the public key) of an authorization body such as the technician's employer. The expiration value is checked to ensure that it has not expired. Optionally, the access right(s) (e.g., permissions, access level or type of user) included in the login details is/are checked to verify whether the technician is authorized to access requested functionality or to allow and/or disallow functionality based on the verified access right(s). The authentication application provides the technician access to a computing resource logged in under the username responsively to authenticating the digital signature and the expiration value.

In the above manner, the technician may be provided with time/date limited access to the computing resources at the different unconnected processing devices. The access is secured using the digital signature and the PIC thereby providing two-factor security, which restricts use of the computing resources to individual technicians (based on the PIC) and identifies each technician logged into the computing resources (based on the username).

In some exemplary modes, the authorization application generates the authentication file to include a signature of the expiration value, username and PIC. In these exemplary modes, the expiration value may be stored in the clear in the mobile storage device and the PIC is generally not used to form an encryption key. In these exemplary modes, at one of the unconnected processing devices, the technician is prompted to enter the PIC and username (if the username is not stored in the mobile storage device). Then, the authentication application verifies the digital signature (thereby authenticating the username, expiration date and PIC), and checks the expiration value. The authentication application provides the technician access to a computing resource logged in under the username responsively to authenticating the digital signature and the expiration value.

In some exemplary modes, the authentication file may also include a user revocation list. The user revocation list may list users of revoked but non-expired authentication files or the revoked but non-expired authentication files. For example, technicians such as Eve and Mallory have left their job, but their authentication files on their mobile storage devices are still valid for another few weeks. Therefore, Eve and Mallory could illegitimately access the computing resources using their respective mobile storage devices. If Alice, a current employed technician requests a new authentication file during this time period, a user revocation list listing both Eve and Mallory (e.g., their emails, usernames, and/or other identification details such as details of the authentication files that were generated for them) may be added to the new authentication file so that when Alice logs in to different devices the user revocation list may be copied to the respective devices so that when Eve and Mallory try to log in to those devices Eve and Mallory will be blocked based on that user revocation list. Therefore, the process of requesting an authentication file and logging in to a device based on the authentication file, results in the user revocation list being copied to the device which is being logged in to. The user revocation list is included in the authentication file, and the digital signature also signs the user revocation list so that the authenticity of the user revocation list may be checked when the user logs in to a device.

In some exemplary modes, the user revocation list may include a version identification (ID) (e.g., version number and/or date). The version ID may be used by the device authenticating the list to determine whether a previously stored user revocation list should be replaced by this user revocation list included in the authentication file of the current user logging in to the device. For example, when Alice logs into a medical device, the medical device checks whether the version ID (e.g., date) of the user revocation list included in Alice's authentication file is newer than the version ID of the user revocation list stored in the memory of the medical device. If it is indeed newer, the medical device will replace its stored user revocation list with the list found in Alice's authentication file.

Although each computing resource at the different unconnected processing devices is loaded with at least one public key for verifying signatures etc., the public key may expire, or the private-public key pair may become compromised. Therefore, it is important to generate one or more spare private-public key pairs, and load at least one spare public key on the devices. However, this is problematic as the devices may not be connected over a network. It should be noted that the new private key cannot be used until its public key counterpart is distributed to all devices in the field. To ease the transition, the authentication file may be used to distribute the spare public key(s) as described in more detail below.

Therefore, in some exemplary modes, the authentication file may also include at least one spare public key. For example, if Alice, a current employed technician requests a new authentication file, one or more spare public keys may be added to the new authentication file so that when Alice logs in to different devices, the spare public key(s) may be copied to the respective devices for later use. Therefore, the process of requesting an authentication file and logging in to a device based on the authentication file, results in the spare public key(s) being copied to that device. The spare public key(s) may be included in the authentication file, and the digital signature also signs the spare public key(s) so that the authenticity of the spare public key(s) may be checked when the user logs in to a device.

In some exemplary modes, the spare public key(s) may be stored in a public key list in the authentication file. The public key list may also include the public key currently used by the system. The public key list may include a version identification (ID) (e.g., version number and/or date). The version ID may be used by the device to determine whether a previously stored public key list should be replaced by the public key list included in the authentication file of the current user logging in to the device. For example, when Alice logs into a medical device, the medical device checks whether the version ID (e.g., date) of the public key list included in Alice's authentication file is newer than the version ID of the public key list stored in the memory of the medical device. If it is indeed newer, the medical device will replace its stored public key list with the list found in Alice's authentication file. The public keys in the new public key list may then be used by the device to check digital signatures presented to the device.

Once all unconnected devices learn the new public key(s), new authentication files may be signed with the private key of the new public key. From then on, the public key list stored in the authentication file does not need to include the old public key, and eventually, all the unconnected devices will forget the old public key as the public key list is replaced in those devices.

The present disclosure uses the term “technician” by way of example only. The term “technician” is to be understood as describing the actions of any suitable user and not just someone acting as a technician.

### System Description

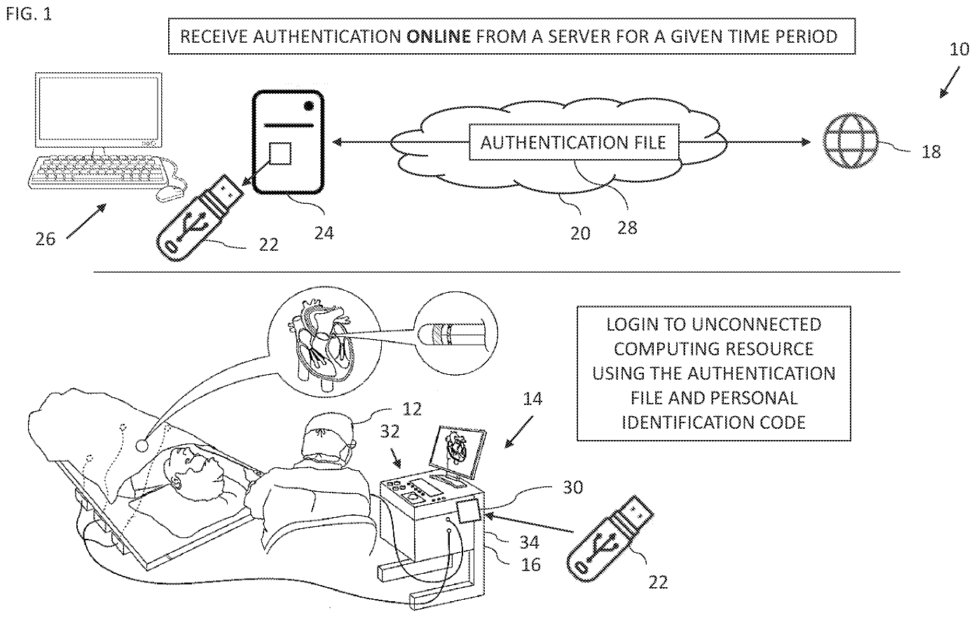

Reference is now made to FIG. 1, which is a partly pictorial, partly block diagram view of a two-factor authorization system 10 constructed and operative in accordance with an exemplary mode of the present disclosure.

The two-factor authorization system 10 is configured to authenticate a technician 12 or any suitable user to use unconnected computing resources 14 (only one shown for the sake of simplicity) of different unconnected processing devices 16 (only one shown for the sake of simplicity).

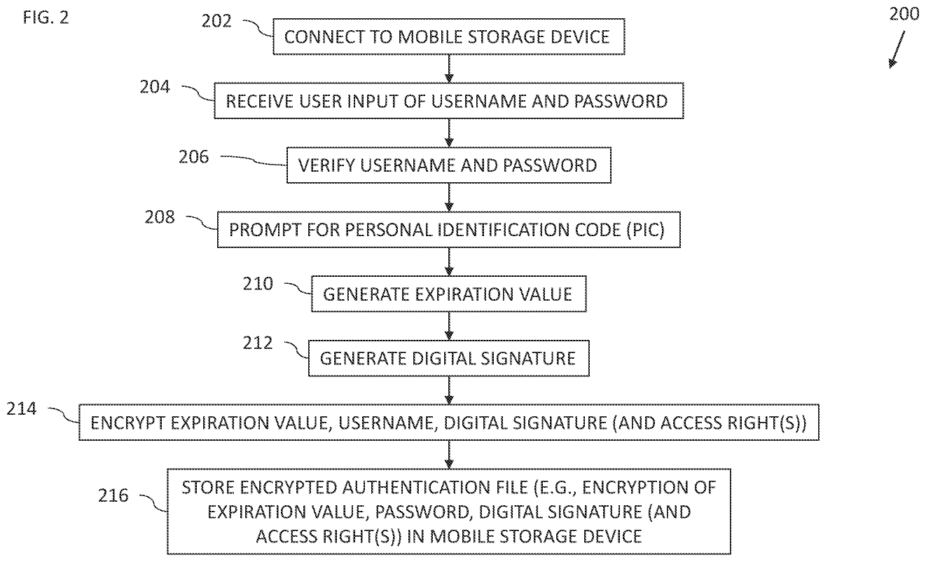

The two-factor authorization system 10 includes an online authorization application (e.g., a web application) running on a server 18 (e.g., web server) over any suitable network 20 (e.g., the Internet). The technician 12 connects a mobile storage device 22 (e.g., flash disk, CD, DVD or SD card) to a computing device 24 (e.g., personal computer, laptop computer, mobile phone or tablet computing device), which is connected to the server 18 over the network 20. The technician 12 enters a username, password, and personal identification code (PIC) via a user input device 26 (e.g., keyboard and/or mouse, or touch screen). The authorization application processes the username, password, and PIC and provides an authentication file 28 for storing in the mobile storage device 22, as described in more detail with reference to FIGS. 2-4. In a similar manner, other technicians may receive personalized authorization files.

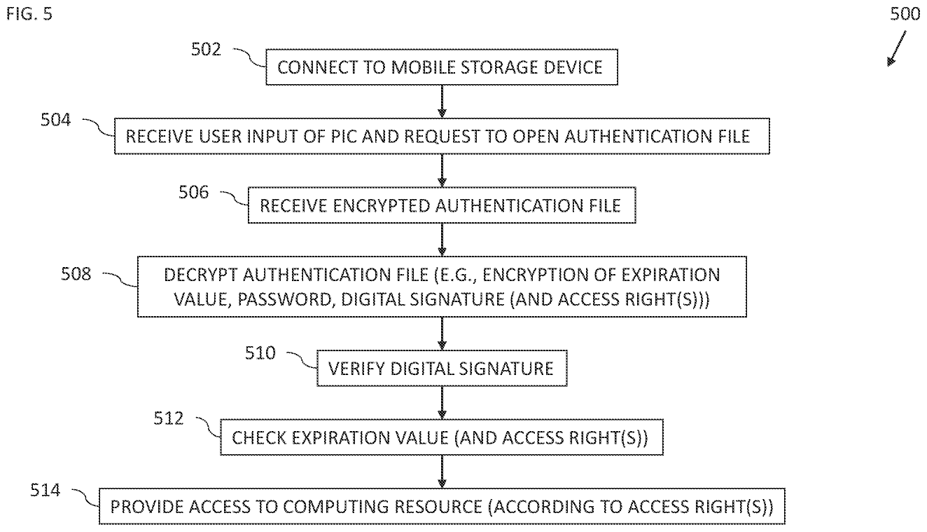

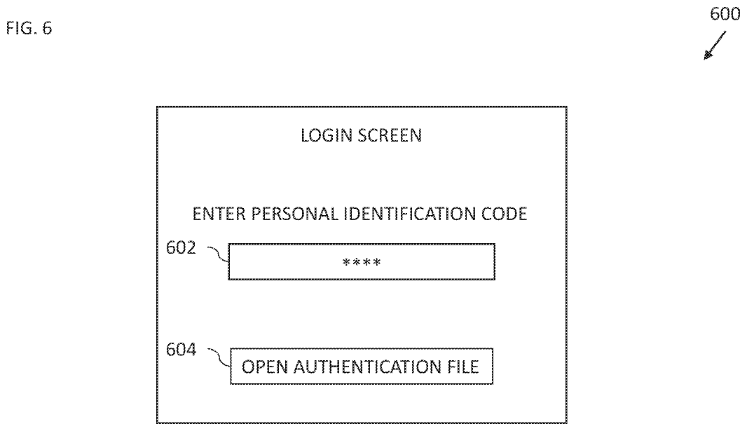

The two-factor authorization system 10 also includes authentication applications running on respective ones of the unconnected processing devices 16 to authenticate the authorization files as described in more detail with reference to FIGS. 5 and 6. Each processing device 16 may include a data interface 30 configured to connect to the mobile storage device 22 (which stores login details (e.g., an expiration value, the username and optionally one or more access rights, for example permissions, access level or type of user.) and a digital signature of the login details typically in encrypted form). Each processing device 16 may include a user input device 32 and processing circuitry 34.

In practice, some or all of the functions of the computing device 24 and the processing circuitry 34 may be combined in a single physical component or, alternatively, implemented using multiple physical components. These physical components may comprise hard-wired or programmable devices, or a combination of the two. In some exemplary modes, at least some of the functions of the computing device 24 and the processing circuitry 34 may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

Reference is now made to FIG. 2, which is a flowchart 200 including steps in a method of generating the authentication file 28 for use in the system 10 of FIG. 1. Reference is also made to FIG. 1.

The technician 12 operationally connects the mobile storage device 22 with the computing device 24. For example, the technician 12 inserts the mobile storage device 22 into a data interface of the computing device 24. The authorization application running on the server 18 is configured to connect (block 202) to the mobile storage device 22.

The authorization application running on the server 18 is configured to receive (block 204) user input of a username of the technician 12, and a password associated with that username. The authorization application running on the server 18 is configured to verify (block 206) the username and password. If the username and password are authenticated, the authorization application running on the server 18 is configured to prompt (block 208) for a personal identification code (PIC), which is typically chosen by the technician 12. In some exemplary modes, the PIC may be generated by the authorization application. The server 18 is configured to receive the entered PIC.

The authorization application running on the server 18 is configured to generate (block 210) an expiration value (e.g., an expiration date), which may be any suitable value. For example, the expiration value may be for a given number of hours, days, weeks or months after the current time/date.

The authorization application running on the server 18 is configured to generate (block 212) a digital signature of login details including the username and expiration value and optionally the access right(s). In some exemplary modes, the authorization application running on the server 18 is configured to generate the digital signature responsively to a private key of a public key infrastructure (e.g., based on a certificate including the private key) of an authorization body such as the technician's employer.

The authorization application running on the server 18 is configured to encrypt (block 214) (e.g., using symmetric encryption) the expiration value and/or the username and/or the digital signature and/or the access right(s) responsively to a key based on the PIC. In some exemplary modes, the expiration value, username, digital signature and optionally the access right(s) are encrypted as a single item. In some exemplary modes, the expiration value, username, digital signature, and optionally the access right(s) are encrypted individually or in any suitable combination thereof. The encrypted expiration value, username, digital signature, and optionally the access right(s) are stored in the authentication file 28.

The authorization application running on the server 18 is configured to store (block 216) the authentication file 28 (including encrypted expiration value, password, the digital signature of the login details and optionally the access right(s)) in the mobile storage device 22 responsively to authenticating the password. In some exemplary modes, the authorization application running on the server 18 is configured to provide the authentication file 28 to a browser running on the computing device 24 so that the technician 12 may select to store the authentication file 28 in the mobile storage device 22.

In some exemplary modes, the expiration value, and/or username, and/or digital signature may be stored in the clear in the authentication file 28 in the mobile storage device 22.

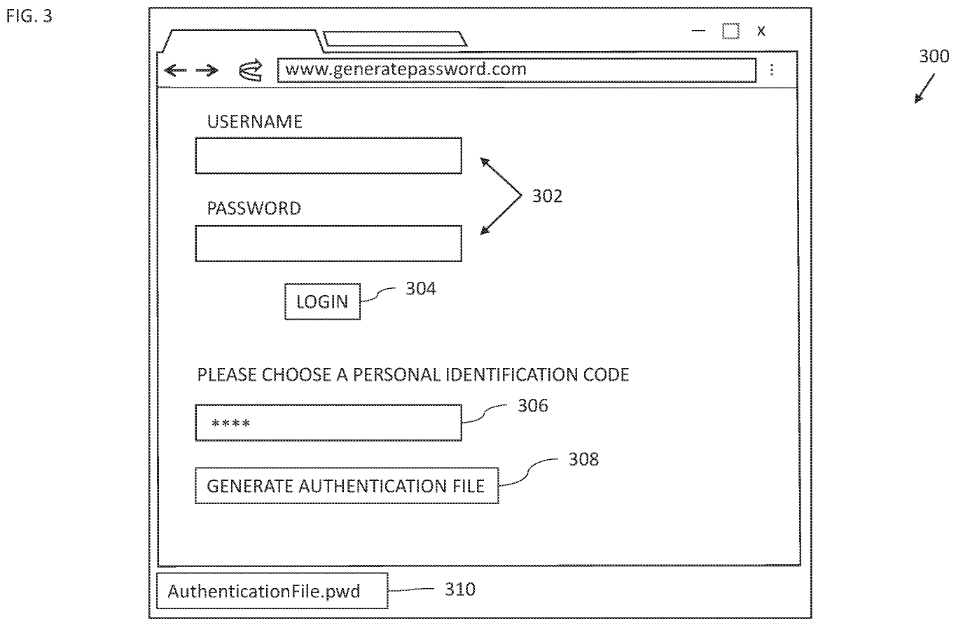

Reference is now made to FIG. 3, which is a schematic view of a user interface screen 300 used by the technician 12 to generate the authentication file 28 in the system 10 of FIG. 1. The user interface screen 300 includes fields 302 for inputting the username and password, and a button 304 to request login to the server 18. The user interface screen 300 includes a field 306 to allow input of the PIC, and a button 308 to request generation of the authentication file 28 as described in FIG. 2. A link 310 to the downloaded authentication file 28 is shown at the bottom of the user interface screen 300, which allows the technician 12 to store the authentication file 28 in the mobile storage device 22.

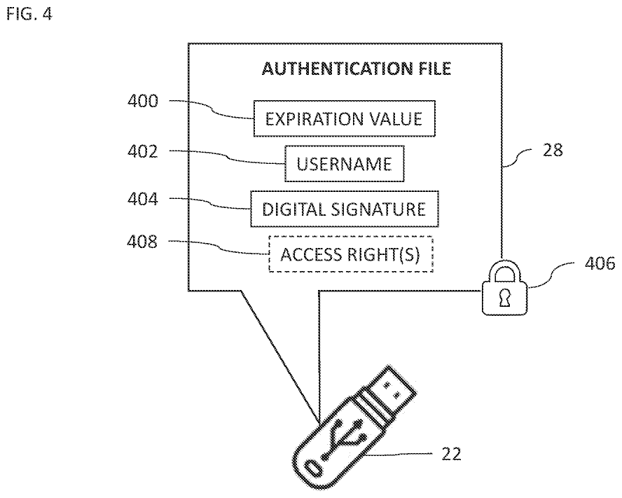

Reference is now made to FIG. 4, which is a schematic view of the mobile storage device 22 with the authentication file 28 stored therein for use with the system 10 of FIG. 1. As shown the authentication file 28 includes the expiration value (block 400), the username (block 402), the digital signature (block 404), and optionally the access right(s) (block 408) secured (block 406) by a suitable encryption algorithm using a key based on the PIC.

Reference is now made to FIG. 5, which is a flowchart 500 including steps in a method of verifying the authentication file to provide access to the computing resource 14 in the system 10 of FIG. 1. Reference is also made to FIG. 1.

Once the authentication file 28 or relevant values are stored in the mobile storage device 22, the technician 12 may take the mobile storage device 22 to any of the unconnected processing devices 16. At one of the selected unconnected processing devices 16 the technician 12 operationally connects the mobile storage device 22 with the data interface 30 of the processing device 16. For example, the technician 12 inserts the mobile storage device 22 into the data interface 30 of the processing device 16. The authentication application running on the processing circuitry 34 is configured to connect (block 502) to the mobile storage device 22.

Reference is now made to FIG. 6, which is a schematic view of a user interface screen 600 used by the technician 12 to login to the computing resource 14 in the system 10 of FIG. 1. The authentication application running on the processing circuitry 34 is configured to present the user interface screen 600 on a display device including a field 602 in which the technician 12 enters the PIC and a button 604 to request opening of the authentication file 28 stored in the mobile storage device 22. The technician 12 enters the PIC in the user interface screen 600 and requests opening of the authentication file 28 stored in the mobile storage device 22.

Reference is again made to FIGS. 1 and 5. The authentication application running on the processing circuitry 34 is configured to receive (block 504) user input of the PIC and the request to open the authentication file 28 via the user input device 32. The authentication application running on the processing circuitry 34 is configured to receive (block 506) the encrypted authentication file 28 including the digital signature, the expiration value, the username, and optionally the access right(s) (in encrypted format) from the mobile storage device 22. In some exemplary modes, the authentication application running on the processing circuitry 34 is configured to symmetrically decrypt (block 508) any one or more of the following included in the authentication file 28: the expiration value; the username; the digital signature; and optionally the access right(s) responsively to a key based on the received personal identification code.

The authentication application running on the processing circuitry 34 is configured to verify (block 510) the digital signature responsively to the expiration value, the username, and optionally the access right(s), to authenticate the expiration value, the username, and optionally the access right(s). In some exemplary modes, the processing circuitry 34 is configured to verify the digital signature responsively to a public key of a public key infrastructure.

The authentication application running on the processing circuitry 34 is configured to check (block 512) that the expiration value has not expired. Optionally the processing circuitry 34 is configured to check the access right(s) (e.g., permissions, access level or type of user) included in the login details to verify whether the technician is authorized to access requested functionality or to allow and/or disallow functionality based on the verified access right(s). The authentication application running on the processing circuitry 34 is configured to provide access (block 514) to the computing resource 14 (optionally according to the verified access right(s) and) logged in under the username responsively to the expiration value and the username being authenticated (with the digital signature) and the expiration value having not expired. The authentication of the digital signature is in turn dependent upon the correct personal identification code being entered by the technician 12 and being used to decrypt the authentication file 28 as described above.

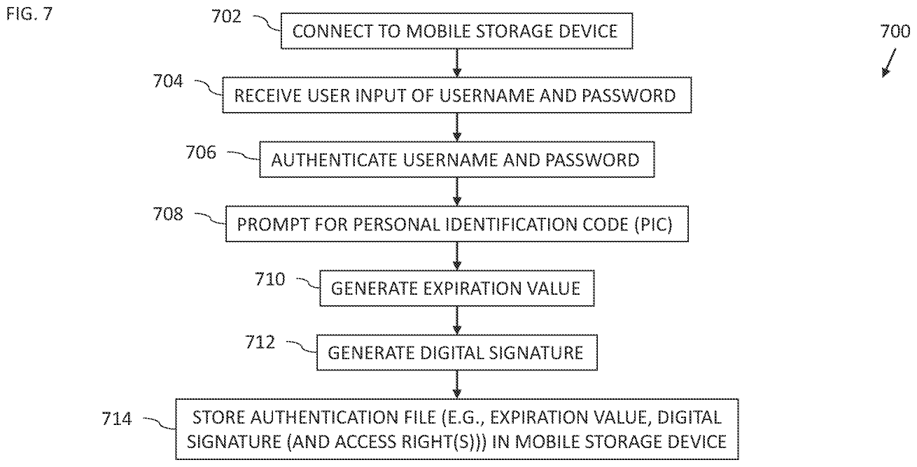

Reference is now made to FIG. 7, which is a flowchart 700 including steps in an alternative method of generating an authentication file for use in the system 10 of FIG. 1. The steps of blocks 702-710 substantially correspond to the steps of blocks 202-210 described above with reference to FIG. 2. The authorization application running on the server 18 is configured to generate (block 712) the digital signature of the login details including the entered personal identification code, the username, the generated expiration value, and optionally the access right(s). The authorization application running on the server 18 is configured to store (block 714) the digital signature (typically in the clear), the expiration file (typically in the clear), and the access right(s) (typically in the clear) as an authentication file in the mobile storage device 22.

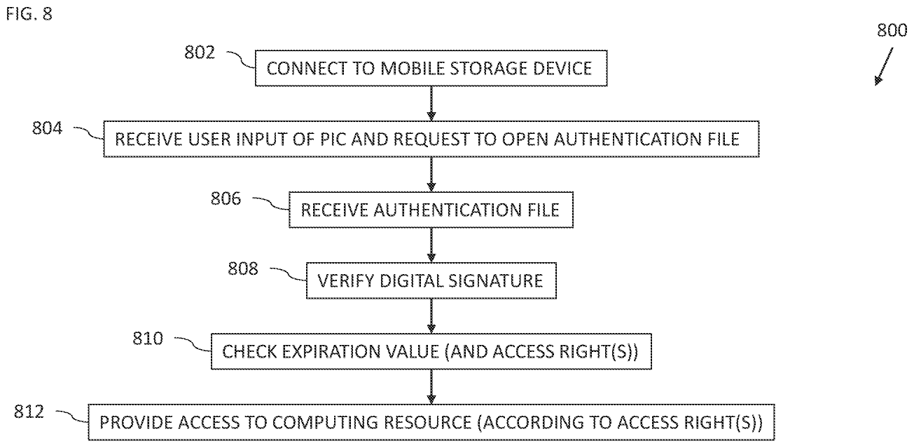

Reference is now made to FIG. 8, which is a flowchart 800 including steps in an alternative method of verifying the authentication file to provide access to the computing resource 14 in the system 10 of FIG. 1. The steps of blocks 802-806 substantially correspond to the steps of blocks 502-506 described above with reference to FIG. 5.

The authentication application running on the processing circuitry 34 is configured to verify (block 808) the digital signature responsively to the expiration value (stored in the authentication file in the mobile storage device 22), the username (which is optionally entered by the technician 12 at the step of block 804), the PIC (entered at the step of block 804), and optionally the access right(s), to authenticate the expiration value, the username, the PIC, and optionally the access right(s). In some exemplary modes, the processing circuitry 34 is configured to verify the digital signature responsively to a public key of a public key infrastructure.

The authentication application running on the processing circuitry 34 is configured to check (block 810) that the expiration value (stored in the authentication file in the mobile storage device 22) has not expired. Optionally the processing circuitry 34 is configured to check the access right(s) (e.g., permissions, access level or type of user) included in the login details to verify whether the technician is authorized to access requested functionality or to allow and/or disallow functionality based on the verified access right(s). The authentication application running on the processing circuitry 34 is configured to provide access (block 812) to the computing resource 14 (optionally according to the verified access right(s) and) logged in under the username responsively to the expiration value, the username, and the PIC being authenticated (with the digital signature) and the expiration value having not expired.

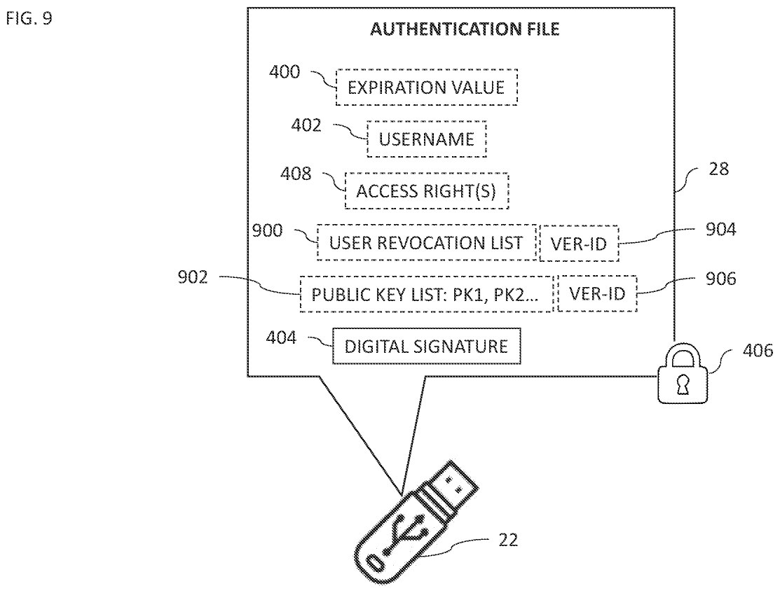

Reference is now made to FIG. 9, which is a schematic view of the mobile storage device 22 of FIG. 4 with the authentication file 28 with more data stored therein for use with system 10 of FIG. 1. The authentication file 28 shown in FIG. 9 may include a user revocation list 900 and/or a public key list 902 among other data.

In some exemplary modes, the authentication file 28 may also include the user revocation list 900 listing users of revoked but non-expired authentication files and/or revoked but non-expired authentication files. For example, technicians such as Eve and Mallory have left their job, but their authentication files 28 on their mobile storage devices 22 are still valid for another few weeks. Therefore, Eve and Mallory could illegitimately access the computing resources 14 using their respective mobile storage devices 22. If Alice, a current employed technician requests a new authentication file during this time period, the user revocation list 900 listing both Eve and Mallory (e.g., their emails, usernames, and/or other identification details such as details of the non-expired authentication files that were generated for them) may be added to the new authentication file 28 so that when Alice logs in to different devices, the user revocation list 900 may be copied to the respective devices so that when Eve and Mallory try to log in to those devices, Eve and Mallory will be blocked based on that user revocation list. Therefore, the process of requesting an authentication file and logging in to a device based on the authentication file, results in the user revocation list 900 being copied to the device. The user revocation list 900 is included in the authentication file 28, and the digital signature (block 404) also digitally signs (e.g., with the current private key) the user revocation list 900 so that the authenticity of the user revocation list 900 may be checked when the user logs in to a device.

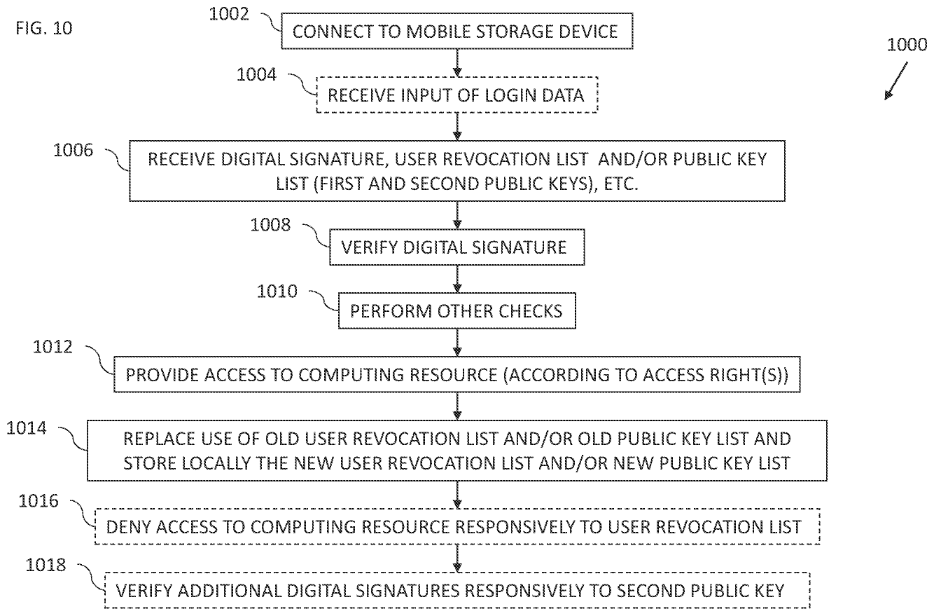

The authentication file 28 may also include a version identification 904 identifying a version of the user revocation list 900. The version identification 904 may include a version number and/or date used to keep track of the latest version of the user revocation list 900, as described in more detail with reference to FIG. 10. For example, when Alice logs into a medical device, the medical device checks whether the version ID 904 (e.g., date) of the user revocation list 900 included in Alice's authentication file 28 is newer than the version ID of the user revocation list stored in the memory of the medical device. If it is indeed newer, the medical device will replace its stored user revocation list with the list found in Alice's authentication file.

The user revocation list 900 may include a list of users who are no longer authorized to connect to devices in the two-factor authorization system 10, for example, technicians who no longer work for a company servicing the computing resources 14. The user revocation list 900 may include a list of users who are no longer authorized to connect to devices in the two-factor authorization system 10 but still have access to non-expired authentication files 28. The user revocation list 900 may include a list of users, usernames, user email address and/or other identifying information such as authentication file 28 assigned to the revoked users.

Although each computing resource at the different unconnected processing devices is loaded with at least one public key for verifying signatures etc., the public key may expire, or the private-public key pair may become compromised. Therefore, it is important to generate one or more spare private-public key pairs, and load at least one spare public key on the devices. However, this is problematic as the devices may not be connected over a network. It should be noted that the new private key cannot be used until its public key counterpart is distributed to all devices in the field. To ease the transition, the authentication file 28 may be used to distribute the spare public key(s) as described in more detail below.

Therefore, in some exemplary modes, the authentication file 28 may also include at least one spare public key. For example, if Alice, a current employed technician requests a new authentication file, one or more spare public keys may be added to the new authentication file 28 so that when Alice logs in to different devices, spare public key(s) may be copied to the respective devices for later use. Therefore, the process of requesting an authentication file and logging in to a device based on the authentication file 28, results in the spare public key(s) being copied to the device. The spare public key(s) may be included in the authentication file 28, and the digital signature (block 404) also digitally signs (e.g., with the current private key) the spare public key(s) so that the authenticity of the spare public key(s) may be checked when the user logs in to a device.

The authentication file 28 may also include a version identification 906 identifying a version of the public key list 902. The version identification 906 may include a version number and/or date used to keep track of the latest version of the public key list 902, as described in more detail with reference to FIG. 10. The public key list 902 may include one or more spare public keys (e.g., PK2) reserved for future use in the two-factor authorization system 10, for example, when a currently used public key (e.g., PK1) expires or if a private key associated with the currently used public key is somehow compromised. The public key list 902 may also include the currently used public key (e.g., PK1). For example, when Alice logs into a medical device, the medical device checks whether the version ID 906 (e.g., date) of the public key list 902 included in Alice's authentication file 28 is newer than the version ID of the public key list stored in the memory of the medical device. If it is indeed newer, the medical device will replace its stored public key list with the list found in Alice's authentication file 28.

The digital signature (block 404) may be generated (e.g., by the server 18 and/or computing device 24) using the currently used private key (e.g., the private key corresponding to PK1) for verification responsively to the currently used public key (e.g., PK1) and digitally sign any one or more of the following: login details (the expiration value (block 400), the username (block 402), the access right(s) (block 408)) and the user revocation list 900 and the public key list 902. Therefore, the mobile storage device 22 which stores the authentication file 28, stores any one or more of the following: the user revocation list 900, the public key list 902, the version identification 904 of the user revocation list 900, and/or the version identification 906 of the public key list 902. The authentication file 28 may be encrypted (block 406).

Reference is now made to FIG. 10, which is a flowchart 1000 including steps in an alternative method of verifying the authentication file 28 to provide access to the computing resources 14 and replace an old user revocation list and/or an old public key list in the system 10 of FIG. 1.

The data interface 30 is configured to connect to the mobile storage device 22 (block 1002), which stores any one or more of the following: the digital signature (block 404 of FIG. 9) (digitally signing any one or more of the following: login details, the user revocation list 900, the version identification 904, the public key list 902 (e.g., including PK2 a spare public key), and/or the version identification 906); the user revocation list 900; the public key list 902; version identification 904; version identification 906; and login details (such as expiration value, username, access rights).

The processing circuitry 34 is optionally configured to receive user input of login data such as the username and PIC (block 1004). The processing circuitry 34 is configured to receive any one or more of the following from the mobile storage device 22: the digital signature (block 404); the user revocation list 900; the public key list 902 (including the spare public key(s), e.g., PK2); the version identification 904; the version identification 906; and optionally login details (block 1006).

The processing circuitry 34 is configured to verify the received digital signature using the current public key (e.g., PK1) responsively to any one or more of the following: the login data (included in the login details of the authentication file 28 or input by the user at the step of block 1004); the user revocation list 900; the public key list 902; version identification 904; version identification 906, to authenticate any one or more of the following: the login data; and the spare public key(s) included in the public key list 902; the user revocation list 900; the version identification 904; and/or the version identification 906 (block 1008). The processing circuitry 34 may be configured to perform other checks described above with reference to FIGS. 1-8, for example, to check that the expiration value of the authentication file 28 is still valid (block 1010). The processing circuitry 34 is configured to provide access to one of the computing resources 14 responsively to the authenticated login data (block 1012) and the other checks performed.

In some exemplary modes, the processing circuitry 34 is configured to replace use of an old user revocation list (stored and used by the processing device 16 currently being accessed) with the authenticated user revocation list 900 (stored in the authentication file 28 of the mobile storage device 22) responsively to the version identification 904 of the authenticated user revocation list 900 indicating that the authenticated user revocation list 900 is newer than the old user revocation list (block 1014). In some exemplary modes, the processing circuitry 34 is configured to replace use of an old public key list (stored and used by the processing device 16 currently being accessed) with the new public key list 902 responsively to the version identification 906 of the new public key list 902 indicating that the new public key list 902 is newer than the old public key list. It should be noted that the old user revocation list 900 and/or the old public key list 902 may be deleted or may be stored by the processing devices 16 but not used.

The processing circuitry 34 in the processing device 16 is configured to deny access to the computing resource 14 responsively to the authenticated user revocation list 900 (block 1016). For example, if a user on the user revocation list 900 tries to access the computing resource 14 of the processing device 16 the access will be denied.

The processing circuitry 34 in the processing device 16 is configured to verify additional digital signatures (for example, for different logins to the processing device 16) with the spare public key (e.g., PK2) responsively to the spare public key being authenticated (i.e., when the public key list 902 was authenticated) (block 1018).

Once all unconnected devices 16 learn the new public key(s), new authentication files 28 may be signed with the private key of the new public key. From then on, the public key list 902 stored in the authentication file 28 does not need to include the old public key, and eventually, all the unconnected devices 16 will forget the old public key as the public key list 902 is replaced in those devices 16.

### EXAMPLES

Example 1: A method to authenticate a user, comprising: connecting to a mobile storage device (22), which stores an expiration value (400) and a digital signature (404) of login details, the login details comprising at least a username (402) and the expiration value; receiving the digital signature and the expiration value from the mobile storage device; receiving a user input of a personal identification code; verifying the digital signature responsively to the expiration value and the username to authenticate the expiration value and the username; checking that the expiration value has not expired; and providing access to a computing resource (14) logged in under the username responsively to the expiration value and the username being authenticated, the expiration value having not expired, and the personal identification code.

Example 2: The method according to example 1, wherein: the login details include at least one access right (408); the verifying includes verifying the digital signature responsively to the expiration value, the username, and the at least one access right to authenticate the expiration value, the username, and the at least one access right; the checking includes checking the at least one access right to verify whether access to functionality is authorized; and the providing access includes providing access to the computing resource according to the verified at least one access right.

Example 3: The method according to example 1 or 2, wherein the mobile storage device stores the expiration value in an encrypted form, the method further comprising decrypting the expiration value responsively to the personal identification code.

Example 4: The method according to any of examples 1-3, wherein the mobile storage device stores the username in an encrypted form, the method further comprising decrypting the username responsively to the personal identification code.

Example 5: The method according to any of examples 1-4, wherein the mobile storage device stores the digital signature in an encrypted form, the method further comprising decrypting the digital signature responsively to the personal identification code.

Example 6: The method according to any of examples 1-5, further comprising symmetrically decrypting at least one of: the expiration value; the username; and the digital signature responsively to the personal identification code.

Example 7: The method according to any of examples 1-6, wherein the digital signature is generated and verified responsively to a private key and a public key of a public key infrastructure, respectively.

Example 8: The method according to any of examples 1-7, further comprising: receiving a user input of the username; and verifying the digital signature responsively to the expiration value, the username, and the personal identification code to authenticate the expiration value, the username, and the personal identification code.

Example 9: The method according to any of examples 1-8, further comprising: connecting a web server to the mobile storage device; receiving user input of the username, a password, and the personal identification code by the web server; generating the expiration value by the web server; generating the digital signature of the login details; and storing the expiration value and the digital signature of the login details in the mobile storage device responsively to authenticating the password.

Example 10: The method according to example 9, further comprising encrypting the expiration value responsively to the personal identification code, wherein the storing comprises storing the encrypted expiration value in the mobile storage device.

Example 11: The method according to example 9 or 10, further comprising encrypting the username responsively to the personal identification code, wherein the storing comprises storing the encrypted username in the mobile storage device.

Example 12: The method according to any of examples 9-11, further comprising encrypting the digital signature responsively to the personal identification code, wherein the storing comprises storing the encrypted digital signature in the mobile storage device.

Example 13: The method according to any of examples 9-12, wherein the login details include the personal identification code.

Example 14: The method according to any of examples 1-13, wherein the mobile storage device stores a user revocation list and the digital signature digitally signs the login details and the user revocation list, the method further comprising: receiving the user revocation list from the mobile storage device; verifying the digital signature responsively to the user revocation list to authenticate the user revocation list; and denying access to the computing resource responsively to the authenticated user revocation list.

Example 15: The method according to example 14, wherein the mobile storage device stores a version identification of the user revocation list, the method further comprising replacing use of an old user revocation list with the authenticated user revocation list responsively to the version identification of the authenticated user revocation list indicating that the authenticated user revocation list is newer than the old user revocation list.

Example 16: The method according to any of examples 1-15, wherein: the digital signature is generated and verified responsively to a first private key and a first public key of a public key infrastructure, respectively; the mobile storage device stores a second public key and the digital signature digitally signs the login details and the second public key, the method further comprising: receiving the second public key from the mobile storage device; verifying the digital signature responsively to the first public key to authenticate the second public key; and verifying additional digital signatures with the second public key responsively to the second public key being authenticated.

Example 17: The method according to example 16, wherein the mobile storage device stores a new public key list including the first public key and the second public key, and a version identification of the new public key list, the method further comprising replacing use of an old public key list with the new public key list responsively to the version identification of the new public key list indicating that the new public key list is newer than the old public key list.

Example 18: A method to authenticate users, comprising: connecting to a mobile storage device (22), which stores a user revocation list (900) and a digital signature (404) of login details and the user revocation list; receiving the digital signature and the user revocation list from the mobile storage device; verifying the digital signature responsively to the user revocation list and login data to authenticate the user revocation list and the login data included in the login details; providing access to a computing resource (12) responsively to the authenticated login data; and denying access to the computing resource responsively to the authenticated user revocation list.

Example 19: The method according to example 18, wherein the mobile storage device stores a version identification (904) of the user revocation list, the method further comprising replacing use of an old user revocation list with the authenticated user revocation list responsively to the version identification of the authenticated user revocation list indicating that the authenticated user revocation list is newer than the old user revocation list.

Example 20: A method to authenticate users, comprising: connecting to a mobile storage device (22), which stores: a digital signature (404) generated responsively to a first private key for verification responsively to a first public key, a second public key, the digital signature digitally signing login details and the second public key; receiving the digital signature and the second public key from the mobile storage device; verify the digital signature responsively to the first public key to authenticate the second public key and login data included in the login details; and providing access to a computing resource (12) responsively to the authenticated login data; verifying additional digital signatures with the second public key responsively to the second public key being authenticated.

Example 21: The method according to example 20, wherein the mobile storage device stores a new public key list (902) including the first public key and the second public key, and a version identification (906) of the new public key list, the method further comprising replacing use of an old public key list with the new public key list responsively to the version identification of the new public key list indicating that the new public key list is newer than the old public key list.

Example 22: A system to authenticate a user, comprising a processing device (16) including: a data interface data (30) configured to connect to a mobile storage device (22), which stores an expiration value (400) and a digital signature (404) of login details, the login details comprising at least a username (402) and the expiration value; a user input device (32); and processing circuitry (34) configured to: receive the digital signature and the expiration value from the mobile storage device; receive a user input of a personal identification code via the user input device; verify the digital signature responsively to the expiration value and the username to authenticate the expiration value and the username; check that the expiration value has not expired; and provide access to a computing resource (12) logged in under the username responsively to the expiration value and the username being authenticated, the expiration value having not expired, and the personal identification code.

Example 23: The system according to example 22, wherein: the login details include at least one access right (408); and the processing circuitry is configured to: verify the digital signature responsively to the expiration value, the username, and the at least one access right to authenticate the expiration value, the username, and the at least one access right; check the at least one access right to verify whether access to functionality is authorized; and provide access to the computing resource according to the verified at least one access right.

Example 24: The system according to example 22 or 23, wherein: the mobile storage device is configured to store the expiration value in an encrypted form; and the processing circuitry is configured to decrypt the expiration value responsively to the personal identification code.

Example 25: The system according to any of examples 22-24, wherein: the mobile storage device is configured to store the username in an encrypted form; and the processing circuitry is configured to decrypt the username responsively to the personal identification code.

Example 26: The system according to any of examples 22-25, wherein: the mobile storage device is configured to store the digital signature in an encrypted form; and the processing circuitry is configured to decrypt the digital signature responsively to the personal identification code.

Example 27: The system according to any of examples 22-26, wherein the processing circuitry is configured to symmetrically decrypt at least one of: the expiration value; the username; and the digital signature responsively to the personal identification code.

Example 28: The system according to any of examples 22-27, wherein the processing circuitry is configured to verify the digital signature responsively to a public key of a public key infrastructure.

Example 29: The system according to any of examples 22-28, wherein the processing circuitry is configured to: receive a user input of the username; and verify the digital signature responsively to the expiration value, the username, and the personal identification code to authenticate the expiration value, the username, and the personal identification code.

Example 30: The system according to any of examples 22-29, further comprising a server configured to: connect to the mobile storage device; receive user input of the username, a password, and the personal identification code; generate the expiration value; generate the digital signature of the login details; and store the expiration value and the digital signature of the login details in the mobile storage device responsively to authenticating the password.

Example 31: The system according to example 30, wherein the server is configured to generate the digital signature responsively to a private key of a public key infrastructure.

Example 32: The system according to example 30 or 31, wherein the server is configured to: encrypt the expiration value responsively to the personal identification code; and store the encrypted expiration value in the mobile storage device.

Example 33: The system according to any of examples 30-32, wherein the server is configured to: encrypt the username responsively to the personal identification code; and store the encrypted username in the mobile storage device.

Example 34: The system according to any of examples 30-33, wherein the server is configured to: encrypt the digital signature responsively to the personal identification code; and store the encrypted digital signature in the mobile storage device.

Example 35: The system according to any of examples 30-34, wherein the login details include the personal identification code.

Example 36: The system according to any of examples 22-35, wherein: the mobile storage device stores a user revocation list and the digital signature digitally signs the login details and the user revocation list; and the processing circuitry is configured to: receive the user revocation list from the mobile storage device; verify the digital signature responsively to the user revocation list to authenticate the user revocation list; and deny access to the computing resource responsively to the authenticated user revocation list.

Example 37: The system according to example 36, wherein: the mobile storage device stores a version identification of the user revocation list; and the processing circuitry is configured to replace use of an old user revocation list with the authenticated user revocation list responsively to the version identification of the authenticated user revocation list indicating that the authenticated user revocation list is newer than the old user revocation list.

Example 38: The system according to any of examples 22-37, wherein: the digital signature is generated and verified responsively to a first private key and a first public key of a public key infrastructure, respectively; the mobile storage device stores a second public key and the digital signature digitally signs the login details and the second public key; and the processing circuitry is configured to: receive the second public key from the mobile storage device; verify the digital signature responsively to the first public key to authenticate the second public key; and verify additional digital signatures with the second public key responsively to the second public key being authenticated.

Example 39: The system according to example 38, wherein: the mobile storage device stores: a new public key list including the first public key, and the second public key; and a version identification of the new public key list; and the processing circuitry is configured to replace use of an old public key list with the new public key list responsively to the version identification of the new public key list indicating that the new public key list is newer than the old public key list.

Example 40: A system to authenticate users, comprising: a data interface (30) configured to connect to a mobile storage device (22), which stores a user revocation list (900) and a digital signature (404) digitally signing login details and the user revocation list; and processing circuitry (34) configured to: receive the digital signature and the user revocation list from the mobile storage device; verify the digital signature responsively to the user revocation list and login data to authenticate the user revocation list and the login data included in the login details; provide access to a computing resource (12) responsively to the authenticated login data; and deny access to the computing resource responsively to the authenticated user revocation list.

Example 41: The system according to example 40, wherein: the mobile storage device stores a version identification (904) of the user revocation list; and the processing circuitry is configured to replace use of an old user revocation list with the authenticated user revocation list responsively to the version identification of the authenticated user revocation list indicating that the authenticated user revocation list is newer than the old user revocation list.

Example 42: A system to authenticate users, comprising: a data interface (30) configured to connect to a mobile storage device (22), which stores: a digital signature (404) generated responsively to a first private key for verification responsively to a first public key, a second public key, the digital signature digitally signing login details and the second public key; and processing circuitry (36) configured to: receive the digital signature and the second public key from the mobile storage device; verify the digital signature responsively to the first public key to authenticate the second public key and login data included in the login details; provide access to a computing resource responsively to the authenticated login data; verify additional digital signatures with the second public key responsively to the second public key being authenticated.

Example 43: The system according to example 42, wherein: the mobile storage device stores a new public key list (902) including the first public key and the second public key, and a version identification (906) of the new public key list; and the processing circuitry is configured to replace use of an old public key list with the new public key list responsively to the version identification of the new public key list indicating that the new public key list is newer than the old public key list.

Various features of the disclosure which are, for clarity, described in the contexts of separate exemplary modes may also be provided in combination in a single exemplary mode. Conversely, various features of the disclosure which are, for brevity, described in the context of a single exemplary mode may also be provided separately or in any suitable sub-combination.

The exemplary modes described above are cited by way of example, and the present disclosure is not limited by what has been particularly shown and described hereinabove. Rather the scope of the disclosure includes both combinations and sub-combinations of the various features described hereinabove, as well as variations and modifications thereof which would occur to persons skilled in the art upon reading the foregoing description and which are not disclosed in the prior art.

What is claimed is:

1. A method to authenticate a user, comprising:
connecting to a mobile storage device, which stores an expiration value and a digital signature of login details, the login details comprising at least a username and the expiration value;
receiving the digital signature and the expiration value from the mobile storage device;
receiving a user input of a personal identification code;
verifying the digital signature responsively to the expiration value and the username to authenticate the expiration value and the username;
checking that the expiration value has not expired; and
providing access to a computing resource logged in under the username responsively to the expiration value and the username being authenticated, the expiration value having not expired, and the personal identification code.

2. The method according to claim 1, wherein:
the login details include at least one access right;
the verifying includes verifying the digital signature responsively to the expiration value, the username, and the at least one access right to authenticate the expiration value, the username, and the at least one access right;
the checking includes checking the at least one access right to verify whether access to functionality is authorized; and
the providing access includes providing access to the computing resource according to the verified at least one access right.

3. The method according to claim 1, wherein the mobile storage device stores the expiration value in an encrypted form, the method further comprising decrypting the expiration value responsively to the personal identification code.

4. The method according to claim 3, wherein the mobile storage device stores the username in an encrypted form, the method further comprising decrypting the username responsively to the personal identification code.

5. The method according to claim 1, wherein the mobile storage device stores the digital signature in an encrypted form, the method further comprising decrypting the digital signature responsively to the personal identification code.

6. The method according to claim 1, further comprising symmetrically decrypting at least one of: the expiration value; the username; and the digital signature responsively to the personal identification code.

7. The method according to claim 1, wherein the digital signature is generated and verified responsively to a private key and a public key of a public key infrastructure, respectively.

8. The method according to claim 1, further comprising:
receiving a user input of the username; and
verifying the digital signature responsively to the expiration value, the username, and the personal identification code to authenticate the expiration value, the username, and the personal identification code.

9. The method according to claim 1, further comprising:
connecting a web server to the mobile storage device;
receiving user input of the username, a password, and the personal identification code by the web server;
generating the expiration value by the web server;
generating the digital signature of the login details; and
storing the expiration value and the digital signature of the login details in the mobile storage device responsively to authenticating the password.

10. The method according to claim 9, further comprising encrypting the expiration value responsively to the personal identification code, wherein the storing comprises storing the encrypted expiration value in the mobile storage device.

11. The method according to claim 10, further comprising encrypting the username responsively to the personal identification code, wherein the storing comprises storing the encrypted username in the mobile storage device.

12. The method according to claim 9, further comprising encrypting the digital signature responsively to the personal identification code, wherein the storing comprises storing the encrypted digital signature in the mobile storage device.

13. The method according to claim 9, wherein the login details include the personal identification code.

14. The method according to claim 1, wherein the mobile storage device stores a user revocation list, and the digital signature digitally signs the login details and the user revocation list, the method further comprising:
receiving the user revocation list from the mobile storage device;
verifying the digital signature responsively to the user revocation list to authenticate the user revocation list; and
denying access to the computing resource responsively to the authenticated user revocation list.

15. The method according to claim 14, wherein the mobile storage device stores a version identification of the user revocation list, the method further comprising replacing use of an old user revocation list with the authenticated user revocation list responsively to the version identification of the authenticated user revocation list indicating that the authenticated user revocation list is newer than the old user revocation list.

16. The method according to claim 1, wherein:
the digital signature is generated and verified responsively to a first private key and a first public key of a public key infrastructure, respectively;
the mobile storage device stores a second public key, and the digital signature digitally signs the login details and the second public key, the method further comprising:
receiving the second public key from the mobile storage device;
verifying the digital signature responsively to the first public key to authenticate the second public key; and
verifying additional digital signatures with the second public key responsively to the second public key being authenticated.

17. The method according to claim 16, wherein the mobile storage device stores a new public key list including the first public key and the second public key, and a version identification of the new public key list, the method further comprising replacing use of an old public key list with the new public key list responsively to the version identification of the new public key list indicating that the new public key list is newer than the old public key list.

18. A method to authenticate users, comprising:
connecting to a mobile storage device, which stores a user revocation list and a digital signature of login details and the user revocation list;
receiving the digital signature and the user revocation list from the mobile storage device;
verifying the digital signature responsively to the user revocation list and login data to authenticate the user revocation list and the login data included in the login details;
providing access to a computing resource responsively to the authenticated login data; and
denying access to the computing resource responsively to the authenticated user revocation list.

19. The method according to claim 18, wherein the mobile storage device stores a version identification of the user revocation list, the method further comprising replacing use of an old user revocation list with the authenticated user revocation list responsively to the version identification of the authenticated user revocation list indicating that the authenticated user revocation list is newer than the old user revocation list.

20. A method to authenticate users, comprising:
connecting to a mobile storage device, which stores: a digital signature generated responsively to a first private key for verification responsively to a first public key, a second public key, the digital signature digitally signing login details and the second public key;
receiving the digital signature and the second public key from the mobile storage device;
verify the digital signature responsively to the first public key to authenticate the second public key and login data included in the login details; and
providing access to a computing resource responsively to the authenticated login data;
verifying additional digital signatures with the second public key responsively to the second public key being authenticated.

21. The method according to claim 20, wherein the mobile storage device stores a new public key list including the first public key and the second public key, and a version identification of the new public key list, the method further comprising replacing use of an old public key list with the new public key list responsively to the version identification of the new public key list indicating that the new public key list is newer than the old public key list.

22. A system to authenticate a user, comprising a processing device including:
a data interface configured to connect to a mobile storage device, which stores an expiration value and a digital signature of login details, the login details comprising at least a username and the expiration value;
a user input device; and
processing circuitry configured to: receive the digital signature and the expiration value from the mobile storage device; receive a user input of a personal identification code via the user input device; verify the digital signature responsively to the expiration value and the username to authenticate the expiration value and the username; check that the expiration value has not expired; and provide access to a computing resource logged in under the username responsively to the expiration value and the username being authenticated, the expiration value having not expired, and the personal identification code.

23. The system according to claim 22, wherein:
the login details include at least one access right; and
the processing circuitry is configured to:
verify the digital signature responsively to the expiration value, the username, and the at least one access right to authenticate the expiration value, the username, and the at least one access right;
check the at least one access right to verify whether access to functionality is authorized; and
provide access to the computing resource according to the verified at least one access right.

24. The system according to claim 22, wherein:
the mobile storage device is configured to store the expiration value in an encrypted form; and
the processing circuitry is configured to decrypt the expiration value responsively to the personal identification code.

25. The system according to claim 24, wherein:
the mobile storage device is configured to store the username in an encrypted form; and
the processing circuitry is configured to decrypt the username responsively to the personal identification code.

26. The system according to claim 22, wherein:
the mobile storage device is configured to store the digital signature in an encrypted form; and
the processing circuitry is configured to decrypt the digital signature responsively to the personal identification code.

27. The system according to claim 22, wherein the processing circuitry is configured to symmetrically decrypt at least one of: the expiration value; the username; and the digital signature responsively to the personal identification code.

28. The system according to claim 22, wherein the processing circuitry is configured to verify the digital signature responsively to a public key of a public key infrastructure.

29. The system according to claim 22, wherein the processing circuitry is configured to:
receive a user input of the username; and
verify the digital signature responsively to the expiration value, the username, and the personal identification code to authenticate the expiration value, the username, and the personal identification code.

30. The system according to claim 22, further comprising a server configured to:
connect to the mobile storage device;
receive user input of the username, a password, and the personal identification code;
generate the expiration value;
generate the digital signature of the login details; and
store the expiration value and the digital signature of the login details in the mobile storage device responsively to authenticating the password.

31. The system according to claim 30, wherein the server is configured to generate the digital signature responsively to a private key of a public key infrastructure.

32. The system according to claim 30, wherein the server is configured to:
encrypt the expiration value responsively to the personal identification code; and
store the encrypted expiration value in the mobile storage device.

33. The system according to claim 32, wherein the server is configured to:
encrypt the username responsively to the personal identification code; and
store the encrypted username in the mobile storage device.

34. The system according to claim 30, wherein the server is configured to:
encrypt the digital signature responsively to the personal identification code; and
store the encrypted digital signature in the mobile storage device.

35. The system according to claim 30, wherein the login details include the personal identification code.

36. The system according to claim 22, wherein:
the mobile storage device stores a user revocation list, and the digital signature digitally signs the login details and the user revocation list; and
the processing circuitry is configured to:
receive the user revocation list from the mobile storage device;
verify the digital signature responsively to the user revocation list to authenticate the user revocation list; and
deny access to the computing resource responsively to the authenticated user revocation list.

37. The system according to claim 36, wherein:
the mobile storage device stores a version identification of the user revocation list; and
the processing circuitry is configured to replace use of an old user revocation list with the authenticated user revocation list responsively to the version identification of the authenticated user revocation list indicating that the authenticated user revocation list is newer than the old user revocation list.

38. The system according to claim 22, wherein:
the digital signature is generated and verified responsively to a first private key and a first public key of a public key infrastructure, respectively;
the mobile storage device stores a second public key, and the digital signature digitally signs the login details and the second public key; and
the processing circuitry is configured to:
receive the second public key from the mobile storage device;
verify the digital signature responsively to the first public key to authenticate the second public key; and
verify additional digital signatures with the second public key responsively to the second public key being authenticated.

39. The system according to claim 38, wherein:
the mobile storage device stores: a new public key list including the first public key, and the second public key; and a version identification of the new public key list; and
the processing circuitry is configured to replace use of an old public key list with the new public key list responsively to the version identification of the new public key list indicating that the new public key list is newer than the old public key list.

40. A system to authenticate users, comprising:
a data interface configured to connect to a mobile storage device, which stores a user revocation list and a digital signature digitally signing login details and the user revocation list; and
processing circuitry configured to:
receive the digital signature and the user revocation list from the mobile storage device;
verify the digital signature responsively to the user revocation list and login data to authenticate the user revocation list and the login data included in the login details;
provide access to a computing resource responsively to the authenticated login data; and
deny access to the computing resource responsively to the authenticated user revocation list.

41. The system according to claim 40, wherein:
the mobile storage device stores a version identification of the user revocation list; and
the processing circuitry is configured to replace use of an old user revocation list with the authenticated user revocation list responsively to the version identification of the authenticated user revocation list indicating that the authenticated user revocation list is newer than the old user revocation list.

42. A system to authenticate users, comprising:
a data interface configured to connect to a mobile storage device, which stores: a digital signature generated responsively to a first private key for verification responsively to a first public key, a second public key, the digital signature digitally signing login details and the second public key; and
processing circuitry configured to:
receive the digital signature and the second public key from the mobile storage device;
verify the digital signature responsively to the first public key to authenticate the second public key and login data included in the login details;
provide access to a computing resource responsively to the authenticated login data;
verify additional digital signatures with the second public key responsively to the second public key being authenticated.

43. The system according to claim 42, wherein:
the mobile storage device stores a new public key list including the first public key and the second public key, and a version identification of the new public key list; and
the processing circuitry is configured to replace use of an old public key list with the new public key list responsively to the version identification of the new public key list indicating that the new public key list is newer than the old public key list.
